(19) United States
(12) Patent Application Publication
(10) Pub. No.: US 2019/0375093 A1
(43) Pub. Date: Dec. 12, 2019

(54) MOVING ROBOT AND OPERATING METHOD FOR THE SAME

(71) Applicant: LG ELECTRONICS INC., Seoul (KR)

(72) Inventors: Seunghee KIM, Seoul (KR); Yongjae KIM, Seoul (KR); Junhee YEO, Seoul (KR)

(73) Assignee: LG ELECTRONICS INC., Seoul (KR)

(21) Appl. No.: 16/440,919

(22) Filed: Jun. 13, 2019

(30) Foreign Application Priority Data
Jun. 14, 2018 (KR) 10-2018-0067880

(51) Int. Cl. B25J 5/00; H04W 4/024; B25J 11/00; B64F 1/36

(52) U.S. Cl. CPC B25J 5/007; B64F 1/368; B25J 11/008; H04W 4/024

(57) ABSTRACT

A apparatus includes a display; and a controller configured to: cause the display to display a user interface screen for a baggage; acquire information from a baggage check presented to the apparatus; and cause the display to display a list of at least one arrived airline flight based on the acquired information. In one embodiment, the apparatus may be a moving robot that can move by itself.

### CROSS-REFERENCE TO RELATED APPLICATION

Pursuant to 35 U.S.C. § 119(a), this application claims the benefit of earlier filing date and right of priority to Korean Patent Application No. 10-2018-0067880, filed on Jun. 14, 2018, the contents of which are incorporated by reference herein in their entirety.

### BACKGROUND OF THE INVENTION

### 1. Field of the Invention

The present invention relates to an apparatus and an operating method for the same, and more particularly, to a moving apparatus or robot capable of providing a guidance service, and an operating method for the same.

### 2. Description of the Related Art

In public places such as airport, railway station, harbor, department store, and theater, information is provided to users through an electronic display board, indicator board, and the like. However, the electronic display board, the indicator board, and the like transmit only some information selected by a service provider unilaterally, and cannot meet the demands of individual users.

Meanwhile, in recent years, the introduction of kiosks for providing information and services to users using multimedia devices such as display means, touch screens, speakers, and the like is increasing. However, even in this case, since the user has to manipulate the kiosk directly, a user may have difficulty in using a device and it would be inconvenient for the user to use the kiosk because the kiosk cannot actively respond to the request of the user.

Meanwhile, robots have been developed for industrial use and have been part of factory automation. In recent years, the application field of robots has been expanded, and thus, medical robots, aerospace robots, and the like have been developed, and household robots that can be used in ordinary homes have been manufactured.

Therefore, research on ways to provide various services such as guidance and advertisement in public places using robots is increasing.

Meanwhile, the moving robot is capable of moving by itself, is free to move, and has a plurality of means for avoiding obstacles during traveling, so that it can travel while avoiding obstacles and cliffs.

For example, Korean Patent Laid-Open Publication No. 10-2013-0141979 discloses a moving robot having a light source unit for irradiating light in a cross pattern and a camera unit for acquiring a forward image.

An infrared sensor or an ultrasonic sensor may be used for detecting an obstacle of the moving robot. The moving robot determines the presence and distance of the obstacle through the infrared sensor, and the ultrasonic sensor emits an ultrasonic wave having a certain cycle.

When there is an ultrasonic wave reflected by the obstacle, the ultrasonic sensor can determine a distance to the obstacle by using a time difference between a time when the ultrasonic wave is emitted and a moment when the ultrasonic wave is returned after being reflected by the obstacle.

A moving robot operated in public places such as airports, railway stations, department stores, and ports where many people stay or move can recognize people and obstacles, and can automatically travel and provide various services.

Such a moving robot is required to serve to quickly and accurately search specific information desired by people and provide the searched information effectively.

Accordingly, there is a need for a method of determining whether it is possible to guide, as well as a method for the moving robot to automatically travel while ensuring safety by recognizing a person or an obstacle.

### SUMMARY OF THE INVENTION

The present invention has been made in view of the above problems, and provides an apparatus or moving robot that can quickly and accurately search specific information desired by people and effectively provide the searched information, and an operating method for the same.

The present invention further provides an apparatus or moving robot that can quickly find a baggage claim based on a baggage check, and an operating method for the same.

The present invention further provides an apparatus or moving robot that can provide an escort service up to a baggage claim and improve user convenience, and an operating method for the same.

In accordance with an aspect of the present invention, an apparatus includes: a display; and a controller configured to: cause the display to display a user interface screen for a baggage; acquire information from a baggage check presented to the apparatus; and cause the display to display a list of at least one arrived airline flight based on the acquired information.

In accordance with another aspect of the present invention, a method for operating an apparatus includes: displaying a user interface screen for a baggage on a display; receiving a baggage check; acquiring information from the received baggage check; and displaying a list of at least one arrived airline flight based on the acquired information.

According to at least one of the embodiments of the present invention, specific information desired by people can be quickly and accurately searched and effectively provided.

Further, according to at least one of the embodiments of the present invention, it is possible to quickly find a baggage claim based on the baggage check.

Further, according to at least one of the embodiments of the present invention, an escort service can be provided up to the baggage claim, thereby improving user convenience.

### BRIEF DESCRIPTION OF THE DRAWINGS

The above and other objects, features and advantages of the present invention will be more apparent from the following detailed description in conjunction with the accompanying drawings, in which:

FIG. 1 is a perspective view of a moving robot according to an embodiment of the present invention;

FIG. 2 is a bottom perspective view of a moving robot according to an embodiment of the present invention;

FIG. 3 is a side view of a moving robot according to an embodiment of the present invention;

FIG. 4 is a view illustrating arrangement of displays of a moving robot according to an embodiment of the present invention;

FIG. 5 is a block diagram illustrating a control relationship between main components of a moving robot according to an embodiment of the present invention;

FIG. 6 is a flowchart illustrating an operating method of a moving robot according to an embodiment of the present invention; and

FIGS. 7 to 11 are examples for explaining an operating method of a moving robot according to an embodiment of the present invention.

### DETAILED DESCRIPTION OF THE PREFERRED EMBODIMENTS

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve as different meanings. Accordingly, the suffixes “module” and “unit” may be interchanged with each other. Although the terms “first,” “second,” etc., may be used herein to describe various components, these components should not be limited by these terms. These terms are only used to distinguish one component from another component.

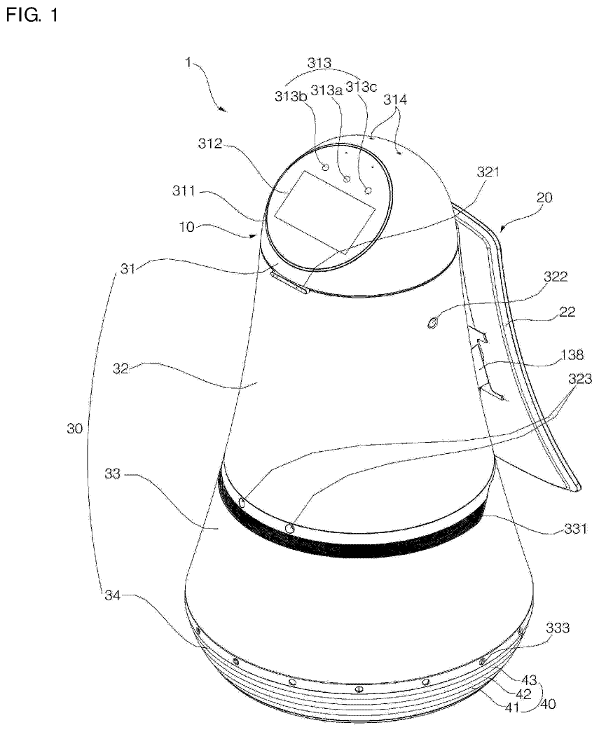

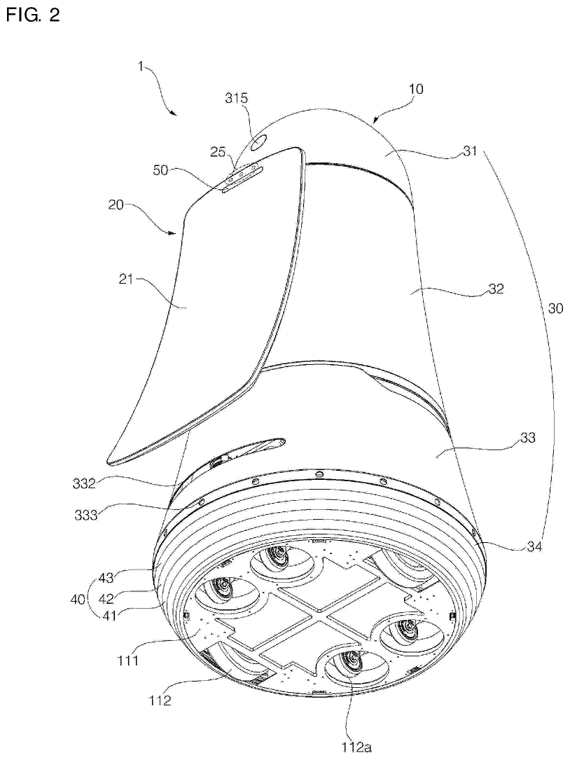

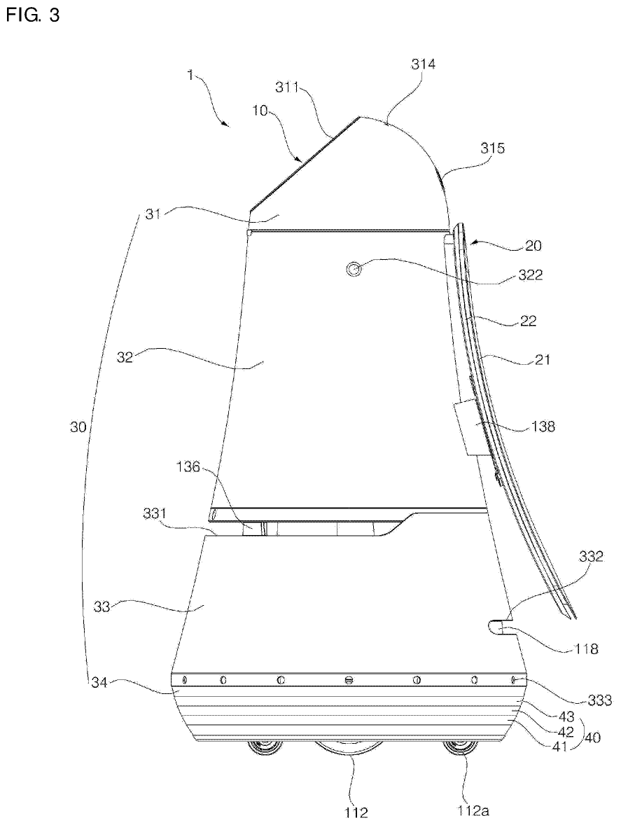

FIG. 1 is a perspective view of a moving robot according to an embodiment of the present invention, FIG. 2 is a bottom perspective view of a moving robot according to an embodiment of the present invention, and FIG. 3 is a side view of a moving robot according to an embodiment of the present invention.

Referring to FIGS. 1 to 3, a moving robot 1 according to an embodiment of the present invention may include a main body 10 that forms an outer appearance and houses various components therein.

The main body 10 may have a longer length in a vertical direction than a length in a horizontal direction, and may have a roly-poly shape that becomes slender as it goes up from the lower part to the upper part.

The main body 10 may include a case 30 forming an outer appearance of the moving robot 1. The case 30 may include a top cover 31 disposed in the upper side, a first middle cover 32 disposed below the top cover 31, a second middle cover 33 disposed below the first middle cover 32, and a bottom cover 34 disposed below the second middle cover 33. Here, the first middle cover 32 and the second middle cover 33 may be implemented by the same middle cover.

The top cover 31 is positioned in the uppermost end of the moving robot 1, and may have a hemispherical shape or a dome shape. The top cover 31 may be positioned at a lower height than adult's height so as to easily receive a command from a user. The top cover 31 may be configured to rotate at a certain angle.

Meanwhile, the top cover 31 is disposed in the uppermost end of the moving robot 1, and houses various components therein, and may have a shape and function similar to those of a human head and accomplish interaction with the user. Therefore, the top cover 31 and the components disposed therein may be referred to as a head. Further, the configuration of the components housed inside the top cover 31 or disposed outside the top cover 31 may be referred to as a head unit. Meanwhile, the remaining portion disposed below the head may be referred to as a body.

The top cover 31 may include an operation unit 311 in one side of a front surface. The operation unit 311 may serve to receive a command from a user. To this end, the operation unit 311 may include a display 312 for receiving a touch input from a user.

The display 312 disposed in the operation unit 311 may be referred to as a first display or a head display 312, and the display included in a display unit 20 disposed in the body may be referred to as a second display or a body display 21.

The head display 312 may form a mutual layer structure with a touch pad to implement a touch screen. In this case, the head display 312 may be used as an input device for inputting information by a user's touch as well as an output device.

In addition, the operation unit 311 may be directed upward by a certain angle so that a user can easily operate the operation unit 311 while viewing the head display 312 downward. For example, the operation unit 311 may be disposed on a surface which is formed by cutting a part of the top cover 31. Accordingly, the head display 312 may be disposed to be inclined.

In addition, the operation unit 311 may have a circular or elliptical shape as a whole. The operation unit 311 may be implemented in a manner similar to a human face shape.

For example, the operation unit 311 has a circular shape, and one or more structures for expressing eyes, nose, mouth, eyebrows, or the like of a human may be positioned on the operation unit 311.

That is, on the operation unit 311, a specific structure may be disposed or a specific paint may be painted to express the eyes, nose, mouth, eyebrows, or the like of a human. Therefore, the operation unit 311 has a human face shape, thereby providing a user with an emotional feeling. Furthermore, when a robot having a human face shape moves, it is possible to give a feeling that a person is moving, thereby relieving the repulsion toward a robot.

As another example, one or more images for expressing the eyes, nose, mouth, eyebrows, or the like of a human may be displayed on the head display 312.

That is, on the head display 312, not only information related to a route guidance service, but also various images for expressing the human face shape may be displayed. On the head display 312, an image for expressing a facial expression determined at a certain time interval or at a specific time may be displayed.

Meanwhile, referring to FIG. 1, the direction in which the body display 21 faces is defined as “rear ward”, and the opposite direction of “rear ward” is defined as “forward”.

In addition, the operation unit 311 may be provided with a head camera unit 313 for recognizing people and objects. The head camera unit 313 may be disposed in the upper side of the head display 312. The head camera unit 313 may include a 2D camera 313a and a RGBD (Red, Green, Blue, Distance) sensor 313b, 313c.

The 2D camera 313a may be a sensor for recognizing a person or an object based on a two-dimensional image.

In addition, the RGBD sensor 313b, 313c may be a sensor for acquiring a person's position or a face image. The RGBD sensor 313b, 313c may be a sensor for detecting a person or an object by using captured images having depth data acquired from a camera having RGBD sensors or from other similar 3D imaging devices.

In order to accurately detect a person's position or a face image, a plurality of RGBD sensors 313b and 313c may be provided. For example, one RGBD sensor 313b may be disposed in the left side of the 2D camera 313a and another RGBD sensor 313c may be disposed in the right side of the 2D camera 313a.

The head camera unit 313 may be configured of a 3D vision sensor such as an RGBD camera sensor. The head camera unit 313 may sense a person present within a certain distance, presence of a guidance object in a guidance mode, a distance between a person and the moving robot 1, a moving speed of a person, or the like.

Meanwhile, although not shown in drawings, the operation unit 311 may further include a physical button for directly receiving a command from a user.

In addition, the top cover 31 may further include a microphone 314. The microphone 314 may serve to receive a command of an audio signal from a user. For example, the microphone 314 may be formed at four points on the upper end portion of the top cover 31 to accurately receive the voice command from the user. Therefore, even when the moving robot 1 is moving or the top cover 31 is rotating, the route guidance request from the user can be accurately received.

In an embodiment of the present invention, the top cover 31 may be rotated so that the operation unit 311 is oriented to the moving direction while the moving robot 1 is moving. When the moving robot 1 receives a command (e.g., voice command) from the user while the moving robot 1 is moving, the top cover 31 may be rotated so that the operation unit 311 is oriented to the direction in which the user is positioned.

Alternatively, when the moving robot 1 receives a command from the user while the moving robot 1 is moving, the top cover 31 may be rotated in a direction opposite to the moving direction of the moving robot 1. That is, the top cover 31 may be rotated in a direction that the body display unit 20 faces. Accordingly, the user may operate the operation unit 311 effectively while viewing guidance service information or the like displayed on the body display unit 20.

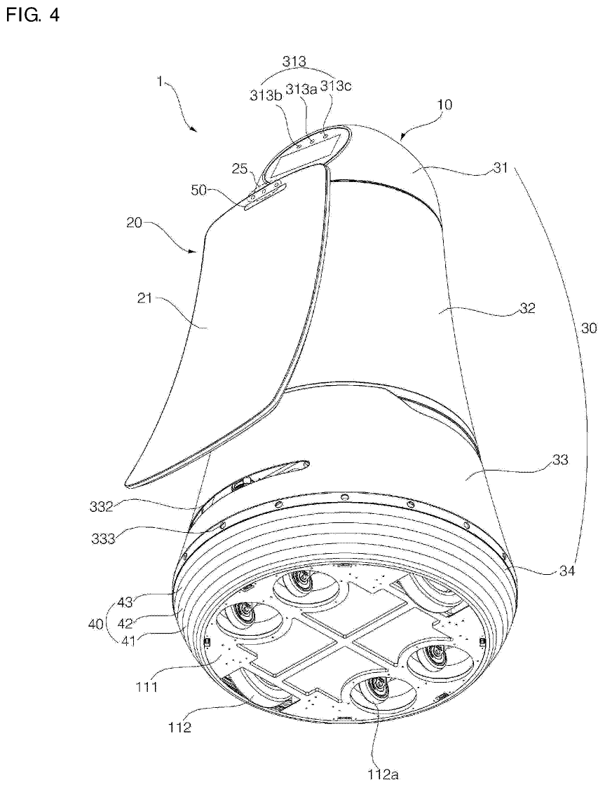

FIG. 4 is a view illustrating arrangement of displays of the moving robot 1 according to an embodiment of the present invention.

Referring to FIG. 4, when the moving robot 1 receives a command from the user in an interaction state or is in a standby state, the displays 312 and 20 may be arranged in one direction, so that a user or users of public places can view the information displayed on the two displays 312, 20 more easily.

The interaction state may correspond to a case where the moving robot 1 provides a voice guidance, a menu screen, or the like to a certain user, receives a touch, voice input from the user, or is providing a guidance service.

Meanwhile, the viewing directions of the operation unit 311 and the body display unit 20 may be opposite to each other. In this case, for example, the operation unit 311 may be oriented toward one direction, and the display unit 20 may be oriented toward the other direction opposite to the one direction. Therefore, there is an advantage in that the information displayed on the operation unit 311 or the body display unit 20 can be viewed from both directions.

Preferably, in a state where the moving robot 1 is traveling or stopped, the directions viewed by the operation unit 311 and the body display unit 20 may be different from each other when the moving robot 1 is moving or stopped.

For example, when the moving robot 1 is moving, as illustrated in FIG. 1, the directions viewed by the operation unit 311 and the body display unit 20 may be opposite to each other.

In addition, when the moving robot 1 is in a standby state, as illustrated in FIG. 4, the directions viewed by the operation unit 311 and the body display unit 20 may be the same

In addition, the top cover 31 may further include an emergency operation button 315. The emergency operation button 315 may serve to immediately stop the operation of the moving robot 1 while the moving robot is stopped or moving. For example, the emergency operation button 315 may be positioned in the rear side of the moving robot 1 so that the emergency operation button 315 can be operated easily, even if the moving robot 1 moves forward.

The first middle cover 32 may be disposed below the top cover 31. Various electronic components including a substrate may be positioned inside the first middle cover 32. The first middle cover 32 may have a cylindrical shape having a larger diameter as it goes downward from the upper portion.

More preferably, the first middle cover 32 may include an RGBD sensor 321.

The RGBD sensor 321 may detect a collision between the moving robot 1 and an obstacle while the moving robot 1 is moving. For this purpose, the RGBD sensor 321 may be positioned in a direction in which the moving robot 1 moves, that is, in the front side of the first middle cover 32.

For example, the RGBD sensor 321 may be positioned in the upper end of the first middle cover 32, taking into account the obstacle or human height present in front of the moving robot 1.

However, the present invention is not limited thereto, and the RGBD sensor 321 may be disposed in various positions in the front side of the first middle cover 32.

According to an embodiment, the RGBD sensor 321 may be constituted by a 3D vision sensor, and may sense a person present within a certain distance, presence of a guidance object in a guidance mode, a distance between a person and the moving robot 1, a moving speed of a person, or the like.

In some embodiments, the RGBD sensor 321 may not be disposed in the first middle cover 32 and the function of the RGBD sensor 321 may be performed in the head camera unit 313.

In addition, the first middle cover 32 may further include a speaker hole 322. The speaker hole 322 is for transmitting sound generated from the speaker to the outside. The speaker hole 322 may be formed on the outer peripheral surface of the first middle cover 32, and a single speaker hole may be formed. Alternatively, a plurality of speaker holes 322 may be formed on the outer peripheral surface of the first middle cover 32 to be spaced apart from each other.

In addition, the first middle cover 32 may further include a stereo camera hole 323. The stereo camera hole 323 is for operation of a stereo camera (not shown in drawings) installed inside the main body 10. For example, the stereo camera hole 323 may be formed in a lower front end of the first middle cover 32. Accordingly, the stereo camera may photograph the front area of the moving robot 1 through the stereo camera hole 323.

The second middle cover 33 may be disposed below the first middle cover 32. A battery, a lidar for autonomous driving, and the like may be positioned inside the second middle cover 33. Like the first middle cover 32, the second middle cover 33 may have a cylindrical shape that has a larger diameter as they progress from the upper portion to the lower portion. The outer side of the second middle cover 33 may be connected to the outer side of the first middle cover 32 without a step. That is, since the outer side of the second middle cover 33 and the outer side of the first middle cover 32 can be connected smoothly, the outer appearance of the moving robot 1 may be more esthetic.

Further, since the first middle cover 32 and the second middle cover 33 have a cylindrical shape that has a larger diameter as they progress from the upper portion to the lower portion, the overall shape may be a roly-poly shape. Therefore, the impact generated when the main body 10 collides with a person or an obstacle can be alleviated.

In detail, the second middle cover 33 may include a first incision portion 331. The first incision portion 331 may be formed laterally in the front side of the outer peripheral surface of the second middle cover 33. The first incision portion 331 is a portion cut from the second middle cover 33 so that a front lidar 136, which will be described later, can be operated.

Specifically, the first incision portion 331 may be cut by a certain length in the radial direction from the outer peripheral surface of the front side of the second middle cover 33. Here, the front lidar 136 is positioned inside the second middle cover 33. The first incision portion 331 may be formed by being cut along the circumference of the second middle cover 33 on the outer peripheral surface of the second middle cover 33 corresponding to the position of the front lidar 136. That is, the first incision portion 331 and the front lidar 136 may face each other. Therefore, the front lidar 136 may be exposed to the outside by the first incision portion 331.

For example, the first incision portion 331 may be cut by 270 degrees around the front side of the second middle cover 33. The reason that the first incision portion 331 should be formed in the second middle cover 33 is to prevent the laser emitted from the front lidar 136 from being directly irradiated to eyes of an adult or a child.

In addition, the second middle cover 33 may further include a second incision portion 332. The second incision portion 332 may be formed laterally in the rear side of the outer peripheral surface of the second middle cover 33. The second incision portion 332 is a portion cut from the second middle cover 33 so that a rear lidar 118, which will be described later, can be operated.

Specifically, the second incision portion 332 may be cut by a certain length in the radial direction from the outer peripheral surface of the rear side of the second middle cover 33. Here, the rear lidar 118 is positioned inside the second middle cover 33. The second incision portion 332 may be formed by being cut along the circumference of the second middle cover 33 at a position corresponding to the position of the rear lidar 118. Therefore, the rear lidar 118 may be exposed to the outside by the second incision portion 332. For example, the second incision 332 may be cut by 130 degrees along the circumference in the rear side of the second middle cover 33.

In the present embodiment, the first incision portion 331 may be spaced apart from the second incision portion 332 in the vertical direction so that the first incision portion 331 and the second incision portion 332 are not connected. The first incision portion 331 may be positioned above the second incision portion 332.

If the first incision portion 331 and the second incision 332 are positioned in the same line, the laser emitted from the lidar of one moving robot may be irradiated to the lidar of the other moving robot. Then, the lasers emitted from the lidars of the respective moving robots may interfere with each other, and thus, accurate distance detection may become difficult. In this case, it is impossible to detect the distance between the moving robot and the obstacle, normal traveling is difficult, and the moving robot and the obstacle may collide with each other.

Further, the second middle cover 33 may further include an ultrasonic sensor 333. The ultrasonic sensor 333 may be a sensor for measuring a distance between an obstacle and the moving robot 1 by using an ultrasonic signal. The ultrasonic sensor 333 may serve to detect an obstacle close to the moving robot 1.

For example, a plurality of ultrasonic sensors 333 may be provided to detect obstacles in all directions close to the moving robot 1. The plurality of ultrasonic sensors 333 may be disposed to be spaced apart from each other around the lower end of the second middle cover 33.

The bottom cover 34 may be disposed below the second middle cover 33. A wheel 112, a caster 112a, and the like may be positioned inside the bottom cover. Unlike the first middle cover 32 and the second middle cover 33, the bottom cover 34 may have a cylindrical shape whose diameter decreases as it progresses from the upper portion to the lower portion. That is, the main body 10 has a roly-poly shape as a whole to reduce the amount of impact applied when the robot is in a collision state, and the lower end of the main body 10 has a structure of becoming narrow inwardly to prevent a human foot from being caught by the wheels of the moving robot 1.

In detail, a base 111 may be positioned inside the bottom cover 34. The base 111 may form a bottom surface of the moving robot 1.

The base 111 may be provided with a wheel 112 for moving of the moving robot 1. Each of a pair of wheels 112 may be positioned in the left and right sides of the base 111, respectively.

In addition, the base 111 may be provided with a caster 112a for assisting the moving of the moving robot 1. Here, the caster 112a may be constituted of a plurality of casters for manual movement of the moving robot 1. For example, two casters 112a may be positioned in the front portion of the base 111, and two casters 112a may be positioned in the rear portion of the base 111, respectively.

According to the above-described caster structure, when the power of the moving robot 1 is turned off or the moving robot 1 is to be manually moved, there is an advantage that the moving robot 1 can be pushed and moved without applying a large force.

The bottom cover 34 may be provided with light emitting modules 40 that include one or more light emitting diodes (LEDs) respectively, and at least one of the light emitting modules 40 may be turned on or off according to the operation state of the moving robot. For example, at least one of the light emitting modules 40 may output light of a certain color or may blink at certain cycles according to the operation state of the moving robot. In addition, two or more light emitting modules among the light emitting modules 40 may output light in a certain pattern according to the operation state of the moving robot 1.

The light emitting modules 40 may include one or more light emitting diodes as a light source respectively. When a plurality of light sources are provided, the plurality of light sources may be disposed with a constant pitch for uniform light supply. The number of light sources and the pitch may be set in consideration of the light intensity. Further, all the colors of the plurality of light sources may be white, or the colors of adjacent light sources may be mixed to emit white light.

The light source may be an aggregate in which a plurality of light emitting diodes are disposed close to each other, as well as a single light emitting diode. In addition, it is also possible to include, for example, a case in which red, blue, and green light emitting diodes, which are three primary colors of light, are disposed close to each other.

Preferably, the light emitting modules 40 may be disposed along the periphery of the bottom cover 34. For example, the light emitting modules 40 may be disposed on any circle that surrounds the periphery of the bottom cover 34 in the horizontal direction.

The light emitting modules 40 may be disposed in the bottom cover 34, which is the lower end of the moving robot 1, so that the light emitting modules 40 may be disposed in a position considerably lower than a human eye level. Accordingly, when the light emitting modules 40 continuously output or blink a specific light, people can feel less glare.

The light emitting modules 40 are disposed to surround the bottom cover 34 in the horizontal direction so that people can see light emitted from the light emitting modules 40 in any direction of 360 degrees.

The light emitting modules 40 are disposed in the bottom cover 34 to be spaced apart from the body display 21 of a large screen which displays a certain image. Accordingly, it is possible to prevent the output light of the light emitting modules 40 and the output image of the body display 21 from deteriorating visibility of each other.

In addition, the light emitting modules 40 may have a plurality of rows and may be disposed in multiple stages. Accordingly, visibility of light outputted by the light emitting modules 40 can be further increased.

For example, the light emitting modules 40 may be disposed in three rows 41, 42, and 43 having different lengths. In this case, the length of the row 41 positioned in the lowermost end of the three rows 41, 42, and 43 may be the shortest.

More preferably, the light emitting modules 40 may be disposed to have a plurality of rows and columns. For example, the light emitting modules 40 may be disposed in three rows 41, 42 and 43, and each row 41, and 43 may include a plurality of light emitting modules which are independently controllable. Accordingly, the light emitting modules 40 may have a plurality of rows and columns, and when the entire light emitting modules 40 are unfolded, they may be disposed in the form of a matrix of M*N.

The body display unit 20 may be formed long in the vertical direction in one side of the moving robot 1. In detail, the body display unit 20 may include the body display 21 and a support portion 22.

The body display 21 may be positioned in the rear side of the first middle cover 32. The body display 21 may serve to output time information (e.g., airport gate inquiry information, route guidance service information, etc.) related to a service currently being provided.

The body display 21 may be a curved surface display having a shape curved outward with a certain curvature. That is, the body display 21 may have a concave shape as a whole. The body display 21 may have a shape that is more tilted backward as it goes down from the upper portion to the lower portion. In other words, the body display 21 may be formed to gradually go further away from the case 30 as it goes down from the upper portion to the lower portion.

According to the display unit structure described above, there is an advantage in that not only the information displayed on the body display 21 is visible in a position far from the moving robot 1, but also the information displayed on the body display 21 is not distorted at various angles.

In addition, according to an embodiment of the present invention, the moving robot 1 may move ahead along a set route to guide the user to the route. The user can see the body display unit 20 installed in the rear side of the moving robot 1 while following the moving robot 1. That is, even if the moving robot 1 moves for guiding the route, the user can easily see the information displayed on the body display unit 20 while following the moving robot 1.

In addition, the upper end of the body display 21 may extend to the upper end of the first middle cover 32 and the lower end of the body display 21 may extend to the second incision portion 332. In this embodiment, the lower end of the body display 21 should be formed not to exceed the second incision portion 332. If the body display 21 is formed to cover the second incision portion 332, the laser emitted from the rear lidar 118 is struck against the lower end of the body display 21. Accordingly, the moving robot 1 may not be able to detect the distance to the obstacle positioned behind.

Meanwhile, the support portion 22 may serve to hold the body display 21 to be positioned in the rear side of the first middle cover 32. The support portion 22 may extend from the rear surface of the body display portion 21. The support portion 22 may be formed to be long in the vertical direction in the rear surface of the body display 21, and may protrude further while progressing downward from the upper portion to the lower portion.

In addition, the support portion 22 may be inserted into the first middle cover 32 through the rear side of the first middle cover 32. For this, a through hole (not shown in drawings) through which the support portion 22 can pass through may be formed in the rear of the first middle cover 32. The through-hole may be formed by cutting a part of the rear side of the outer peripheral surface of the first middle cover 32 rearward.

The body display unit 20 may be fixed to the inside of the main body 10 by a separate fixing member 138.

The fixing member 138 for fixing the body display unit 20 to the main body 10 may be provided inside the main body 10. One side of the fixing member 138 may be fixed to the main body 10 and the other side of the fixing member 138 may be fixed to the body display unit 20. To this end, the other side of the fixing member 138 may protrude to the outside of the case 30 through the through hole. That is, the support portion 22 and the fixing member 138 may be positioned together in the through-hole.

In the present embodiment, the body display unit may be fastened to the fixing member 138 by fastening means. At this time, the support portion 22 of the body display unit 20 may be placed on the upper portion of the fixing member 138. In other words, the support portion 22 may be placed on the upper portion of the fixing member 138, and a part of the fixing member 138 may be fixed to a part of the body display unit 20. With such a display unit fixing structure, the body display unit 20 can be stably positioned in the rear side of the first middle cover 32.

In addition, the body display unit 20 may further include a ticket input port 50. The present embodiment illustrates that the ticket input port 50 is disposed in the body display unit 20, but the present invention is not limited thereto, and the ticket input port 50 may be disposed in other portion of the moving robot 1.

Meanwhile, the moving robot 1 may include a scanner (not shown in drawings) for scanning a ticket inserted into the ticket input port 50, and the scanner may be activated under the control of a controller 740.

According to an embodiment of the present invention, when a ticket such as an airline ticket, a baggage check, and the like is inserted into the ticket input port 50, the scanner provided inside the moving robot 1 may scan a bar code, a QR code, and the like included in the ticket.

In addition, the moving robot 1 may display a scan result on the body display 21, and provide a user with gate information, counter information, etc. according to the scan result.

Meanwhile, the body display unit 20 may further include a body camera unit 25 for identifying and tracking the guidance object. The body camera unit 25 may be constituted of a 3D vision sensor such as an RGBD camera sensor. The body camera unit 25 may sense a person present within a certain distance, presence of a guidance object in a guidance mode, a distance between a person and the moving robot 1, a moving speed of a person, and the like.

In some embodiments, the moving robot 1 may not include the body camera unit 25, but may further include a sensor for identifying and tracking guidance object disposed in other area.

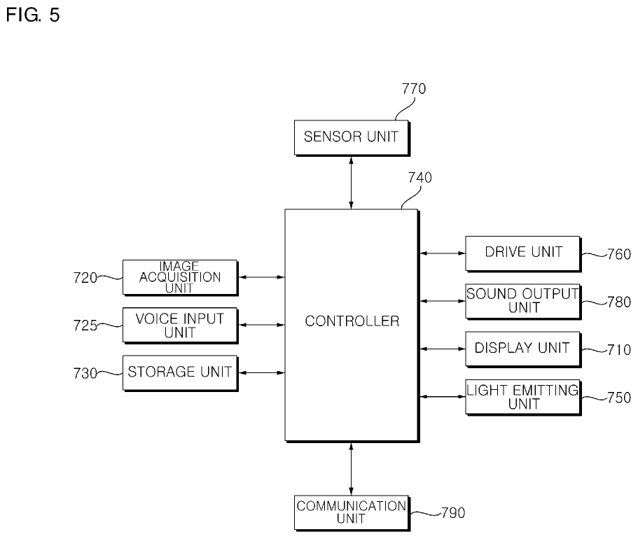

FIG. 5 is a block diagram illustrating a control relationship between main components of a moving robot according to an embodiment of the present invention.

Referring to FIG. 5, the moving robot 1 according to an embodiment of the present invention may include a voice input unit 725 for receiving a user's voice input through the microphone 314, a storage unit 730 for storing various data, a communication unit 790 for transmitting/receiving data to/from other electronic device such as a server (not shown in drawings), a light emitting unit 750 including at least one light emitting module for outputting light to the outside, and a controller 740 for controlling the overall operation of the moving robot 1.

The voice input unit 725 may include a processing unit for converting an analog sound into digital data or may be connected to the processing unit, thereby converting a user input voice signal into data to be recognized by the controller 740 or a server (not shown in drawings).

The controller 740 may control the voice input unit 725, the storage unit 730, the light emitting unit 750, the communication unit 790, and the like constituting the moving robot 1 to control the overall operation of the moving robot 1.

The storage unit 730 records various types of information necessary for controlling the moving robot 1, and may include a volatile or nonvolatile recording medium. The recording medium stores data that can be read by a microprocessor, and includes a hard disk drive (HDD), a solid state disk (SSD), a silicon disk drive (SDD), a ROM, a RAM, a CD-ROM, a magnetic tape, a floppy disk, an optical data storage device, and the like.

In addition, the storage unit 730 may store various data necessary for the moving robot 1 to provide a guidance service.

In addition, the controller 740 may transmit the operation state of the moving robot 1, the user input, or the like to the server through the communication unit 790.

The communication unit 790 includes at least one communication module so that the moving robot 1 is connected to the Internet or a certain network.

Meanwhile, data for voice recognition may be stored in the storage unit 730, and the controller 740 may process a voice input signal of user received through the voice input unit 725 and perform a voice recognition process.

Meanwhile, the controller 740 may control the moving robot 1 to perform a certain operation based on the voice recognition result. For example, when the command included in the voice signal is a command for requesting certain information such as flight departure information, sightseeing guidance information, and the like, the controller 740 may control to display certain information such as flight departure information and sightseeing guidance information on the display unit 710.

In addition, if there is a user's guidance request, the controller 740 may control the moving robot 1 to escort a user to a guidance destination selected by the user.

Meanwhile, the voice recognition process may be performed in the server, not in the moving robot 1 itself. In this case, the controller 740 may control the communication unit 790 to transmit the user input voice signal to the server, and may receive the recognition result of the voice signal from the server through the communication unit 790.

Alternatively, the moving robot 1 may perform simple voice recognition such as caller recognition, and high-level voice recognition such as natural language processing may be performed in the server.

Meanwhile, the moving robot 1 may include a display unit 710 for displaying certain information as an image and a sound output unit 780 for outputting certain information as a sound.

The display unit 710 may display information corresponding to a request input by a user, a processing result corresponding to a request input by the user, an operation mode, an operation state, an error state, and the like as an image.

As described above with reference to FIGS. 1 to 4, the display unit 710 may include a head display 312 and a body display 21. Since the body display 21 is relatively larger in size than the head display 312, it may be preferable to display information on the body display 21 in a large screen.

In addition, the sound output unit 780 may output a notification message such as an alarm sound, an operation mode, an operation state, and an error state, information corresponding to a request input by the user, a processing result corresponding to a request input by the user, and the like. The sound output unit 780 may convert an electrical signal from the controller 740 into an audio signal and output the audio signal. For this purpose, a speaker or the like may be provided.

Meanwhile, the moving robot 1 may include an image acquisition unit 720 for photographing a certain range. The image acquisition unit 720 photographs the surroundings of the moving robot 1, the external environment, and the like, and may include a camera module. Several cameras may be installed for each part of the moving robot for photographing efficiency.

For example, as described above with reference to FIGS. 1 to 4, the image acquisition unit 720 may include a head camera unit 313 for recognizing a person and an object, and a body camera unit 25 for identifying and tracking the guidance object. However, the number, arrangement, type, and photographing range of the cameras included in the image acquisition unit 720 are not necessarily limited thereto.

The image acquisition unit 720 may photograph an image for user recognition. The controller 740 may determine an external situation or recognize a user (guidance object), based on the image photographed and acquired by the image acquisition unit 720.

In addition, the controller 740 may control the moving robot 1 to move, based on the image photographed and acquired by the image acquisition unit 720.

Meanwhile, the image photographed and acquired by the image acquisition unit 720 may be stored in the storage unit 730.

Meanwhile, the moving robot 1 may include a drive unit 760 for moving, and the drive unit 760 may move the main body 10 under the control of the controller 740.

The drive unit 760 may include at least one drive wheel 112 for moving the main body 10 of the moving robot 1.

The drive unit 760 may include a drive motor (not shown in drawings) connected to the drive wheel 112 to rotate the drive wheel.

The drive wheel 112 may be provided in the left and right sides of the main body 10, respectively, and may be referred to as left and right wheels, respectively.

The left wheel and the right wheel may be driven by a single drive motor, but may be provided with a left wheel drive motor for driving the left wheel and a right wheel drive motor for driving the right wheel, respectively, if necessary. The moving direction of the main body 10 may be switched to the left or right side by making a difference in the rotational speeds of the left and right wheels.

Meanwhile, the moving robot 1 may include a sensor unit 770 including sensors for sensing various data related to the operation and state of the moving robot 1.

The sensor unit 770 may include an obstacle detection sensor that detects an obstacle. The obstacle detection sensor may include an infrared sensor, an ultrasonic sensor, an RF sensor, a geomagnetic sensor, a position sensitive device (PSD) sensor, and the like. For example, the obstacle detection sensor may correspond to the ultrasonic sensor 333, the RGBD sensor 321, and the like described above with reference to FIGS. 1 to 4.

In addition, the sensor unit 770 may further include a cliff sensor for detecting presence of a cliff on the floor in a moving area.

In some embodiments, the sensor unit 770 may further include a sensor for detecting a magnitude of a sound acquired through the microphone 314, and accordingly, may sense the magnitude of a voice uttered by the user, and the magnitude of ambient noise.

Alternatively, without further including a separate sensor, the voice input unit 725 may determine the magnitude of the voice of user and the ambient noise during the processing of a signal acquired through the microphone 314.

In addition, the sensor unit 770 may include a light detection and ranging (Lidar) 136, 118. The lidar 136, 118 may detect an object such as an obstacle, based on a Time of Flight (TOF) of a transmission signal and a reception signal or a phase difference between a transmission signal and a reception signal, by a medium of a laser light.

Further, the lidar 136, 118 may detect the distance to the object, the relative speed with the object, and the position of the object.

The lidar 136, 118 may be provided as part of the configuration of the obstacle detection sensor. Further, the lidar 136, 118 may be provided as a sensor for creating a map.

Meanwhile, the obstacle detection sensor detects an object, particularly an obstacle, present in a moving direction of the moving robot 1, and transmits obstacle information to the controller 740. At this time, the controller 740 may control the motion of the moving robot 1 according to the position of the detected obstacle.

The sensor unit 770 may further include a motion sensor for detecting motion of the moving robot 1 according to driving of the main body 101 and outputting motion information. For example, a gyro sensor, a wheel sensor, an acceleration sensor, and the like may be used as the motion sensor.

The gyro sensor senses the rotation direction and detects the rotation angle when the moving robot 1 moves according to the operation mode. The gyro sensor detects the angular velocity of the moving robot 1 and outputs a voltage value proportional to the angular velocity. The controller 740 calculates the rotation direction and the rotation angle by using the voltage value outputted from the gyro sensor.

The wheel sensor is connected to the left and right wheels to detect the number of rotations of the wheel. Here, the wheel sensor may be a rotary encoder. The rotary encoder detects and outputs the number of rotations of the left and right wheels.

The controller 740 may calculate the rotational speeds of the left and right wheels by using the number of rotations. In addition, the controller 740 may calculate the rotation angle by using a difference in the number of rotations of the left and right wheels.

The acceleration sensor detects a speed change of the moving robot 1, for example, a change in the moving robot 1 due to a start, a stop, a direction change, a collision with an object, or the like. The acceleration sensor is attached to the adjacent position of the main wheel or the auxiliary wheel, so that the slip or idling of the wheel can be detected.

In addition, the acceleration sensor is built in the controller 740 and may detect a speed change of the moving robot 1. That is, the acceleration sensor detects impulse due to the speed change and outputs a corresponding voltage value. Thus, the acceleration sensor may perform the function of an electronic bumper.

The controller 740 may calculate the position change of the moving robot 1 based on operation information outputted from the motion sensor. Such a position is a relative position corresponding to the absolute position using image information. The moving robot may improve the performance of the position recognition using the image information and the obstacle information through the relative position recognition.

The light emitting unit 750 may include a plurality of light emitting modules. For example, as described with reference to FIGS. 1 to 4, the light emitting unit 750 may include light emitting modules 40 include one or more light emitting diodes (LEDs) respectively.

In addition, the light emitting modules 40 may be disposed in the bottom cover 34, and the light emitting modules 40 may be operated under the control of the controller 740.

For example, the controller 740 may control at least one of the light emitting modules 40 to output light of a certain color or to blink at certain cycles according to the operation state of the moving robot. In addition, the controller 740 may control two or more modules of the light emitting modules 40 to output light in a certain pattern according to the operation state of the moving robot.

As described above with reference to FIGS. 1 to 5, the moving robot 1 according to an embodiment of the present invention may include a top cover 31 provided to be rotatable, a first display 312 disposed in the top cover 31, a second display 21 having a size larger than the first display 312, middle covers 32, 33 coupled with the second display 21 and the top cover 31, a bottom cover 34 positioned below the middle covers 32, 33, a light emitting unit 750 including light emitting modules 40 disposed along the periphery of the bottom cover 34, and a controller 740 for controlling the light emitting modules 40 based on the current state of the moving robot 1.

Each of the light emitting modules 40 of the light emitting unit 750 may include at least one light source. For example, the light emitting modules 40 may include one or more light emitting diodes (LEDs), respectively.

Conventional analog lighting has a limitation in precisely controlling the illumination, but the light emitting diode (LED) can precisely control the illumination by adjusting the amount of applied current and the width of a driving pulse. In addition, when the light emitting diodes (LEDs) of R, G, and B colors are provided in combination, the light of a specific color can be provided and the adjustment of the color temperature can be easily accomplished.

The light emitting diode (LED) may be a single color light emitting diode (LED) such as Red, Blue, Green, and White. In some embodiments, the light emitting diode (LED) may be a multicolor light emitting diode (LED) for reproducing a plurality of colors.

In addition, the light emitting modules 40 may include a plurality of light emitting diodes (LEDs). All the plurality of light emitting diodes (LEDs) may emit white light to provide white lighting. Red, blue, and green light emitting diodes (LEDs) may be combined to provide illumination of a specific color or a white light.

For example, the light emitting modules 40 may output a first color (White) indicating a normal operation state, a second color (Yellow) indicating a pause state, and a third color (Red) indicating an error state.

The light emitting modules 40 may display the current operation state of the output light through colors and patterns, and may serve as a signal light for informing people of the moving state and the operation state of the moving robot 1.

In addition, the controller 740 may control the light emitting unit 750. For example, the controller 740 may control at least one of the light emitting modules 40 to output light of a certain color according to the current state of the moving robot 1. In addition, the controller 740 may control at least one of the light emitting modules 40 to blink in a certain cycle for a certain time.

When the moving robot 1 moves or travels, even when a user approaches the moving robot 1 for information check, setting input, and other manipulation, or when a child touches the moving robot 1 with curiosity, if the moving robot 1 continues to move, a safety accident such as a collision may occur.

Particularly, public places such as airport, railway station, terminal, department store, and mart have a large number of floating population, and there are many unexpected variables that lead to a higher risk of safety accidents.

Accordingly, when operating in a public place, the moving robot 1 according to the present invention outputs light indicating the current operation state of the moving robot 1 through the light emitting unit 750, thereby providing signal information that allows people present in a public place to easily recognize the current state of the moving robot 1. Accordingly, the possibility of an accident between a person and the moving robot 1 in a public place can be reduced.

Since the light emitting modules 40 are disposed apart from the second display 21 on the bottom cover 34 that is the lower end of the moving robot 1, they can be disposed in a position relatively lower than the eye level of the human and the second display 21. Accordingly, when the light emitting modules 40 continuously output or blink specific light, people can feel less glare, and the output light of the light emitting modules 40 and the output image of the body display 21 can be prevented from deteriorating visibility of each other.

Preferably, the light emitting modules 40 may be disposed along the periphery of the bottom cover 34. The light emitting modules 40 are disposed to surround the bottom cover 34 in the horizontal direction so that people can see light emitted from the light emitting modules 40 in any direction of 360 degrees.

Meanwhile, the light emitting modules 40 may have a plurality of rows and may be disposed in multiple stages. Accordingly, visibility of light outputted by the light emitting modules 40 can be more enhanced.

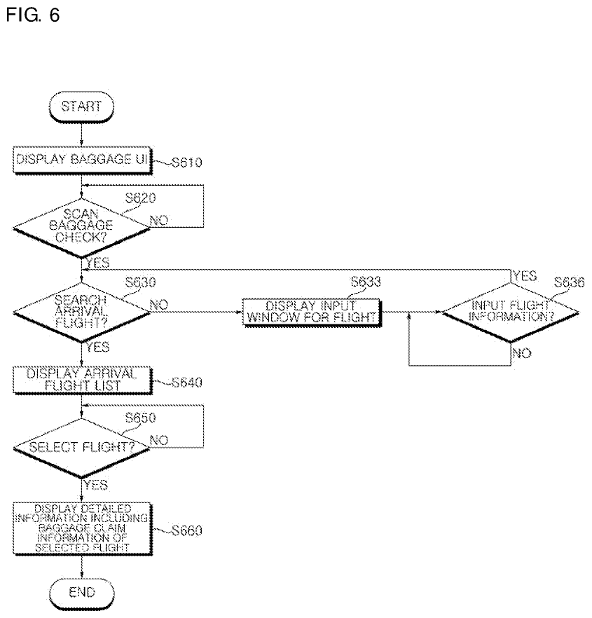

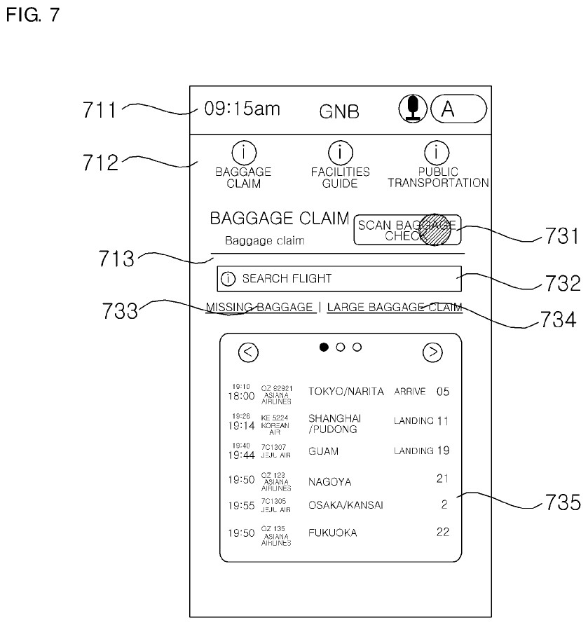

FIG. 6 is a flowchart illustrating an operating method of a moving robot according to an embodiment of the present invention, and FIGS. 7 to 11 are views for explaining an operating method of a moving robot according to an embodiment of the present invention.

Referring to FIGS. 5 and 6, the moving robot 1 may display a baggage-related user interface (UI) screen through the display unit 710 (S610).

The display unit 710 according to an embodiment of the present invention may include the first display 312 and the second display 21, and may display a baggage related user interface screen on the second display 21 having a large screen.

FIG. 7 shows an example of a user interface screen provided through the second display 21.

Referring to FIG. 7, a global navigation bar area 711 in which menu and state information accessible from any screen are displayed may be disposed in the upper end of the second display 21.

In addition, the user interface screen may include menu items 712 for selecting guide information. For example, the menu items 712 may include a baggage claim item for receiving baggage claim related information, a facility guide information item for receiving information on facilities in an airport, a public transportation item for receiving information on public transportation available at an airport, and the like.

When the baggage claim item among the menu items 712 is selected, the baggage related user interface screen may be displayed.

In some embodiments, the moving robot 1 disposed in the arrival hall may be set such that the baggage related user interface screen is displayed by default.

In addition, the baggage related user interface screen may include baggage related items 713. The baggage related items 713 may include a baggage check scan item 731 for scanning a baggage check, a flight input window 732 for searching a flight, a missing baggage item 733 for receiving information on the missing baggage claim, a large baggage item 734 for receiving information on a large baggage claim, and the like.

In addition, baggage related items 713 may include flight information items 735. The flight information item 735 may include a flight number, an estimated arrival time, an altered time, a flight name, an airline, a departure point, a destination arrival, and a baggage reclaim number information.

Meanwhile, referring to FIGS. 1 to 5, the moving robot 1 according to the embodiment of the present invention may include a ticket input port 50 and a scanner (not shown in drawings) for scanning a ticket inserted into the ticket input port 50.

The scanner may be activated under the control of the controller 740. When a ticket such as an air ticket or baggage check is inserted into the ticket input port 50, the scanner may scan a bar code, a QR code, etc. included in the ticket and transmit the scan result to the controller 740.

For example, if a user touches the baggage check scan item 731 or requests scan of the baggage check by voice, the controller 740 may activate the scanner and request insertion of the baggage check. In some embodiments, the scanner may be provided inside the controller 740 as one block of the controller 740.

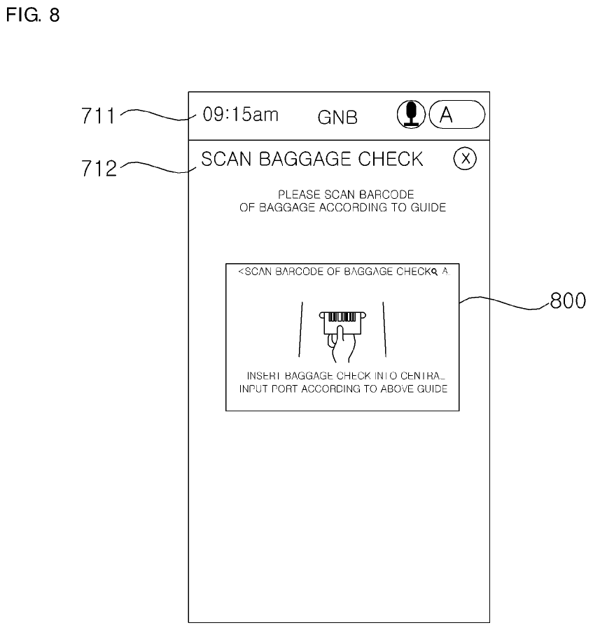

FIG. 8 illustrates a screen displayed when the baggage check scan item 731 included in the baggage-related user interface screen is selected.

Referring to FIG. 8, according to the selection of the baggage check scan item 731, the controller 740 may control the second display 21 to display a screen 800 for guiding to insert the baggage check to the ticket input port 50.

In addition, the controller 740 may control the first display 312 or the second display 21 to display a screen that guides completion of the scanning and recovery of the ticket upon completion of the scanning.

When the baggage check inserted in the ticket input port 50 is scanned (S620), the controller 740 may acquire airline information by scanning the baggage check.

In addition, the controller 740 may control the display unit 740 to display the arrival flight list of the airline, based on the airline information acquired by the scanning of the baggage check (S640).

Even in this case, the arrival flight list of the airline may be displayed on the second display 21 of a large screen.

Meanwhile, the arrival flight list may include the arrival flight of the airline being in a bag drop off state when the passengers of the arrival hall can pick up their baggage in the baggage claim.

Alternatively, the arrival flight list may include the arrival flight of the airline arrived within a reference time from the current time.

In order for the moving robot 1 to guide the baggage claim in the arrival hall, the flight information is required. However, the bar code, QR code, or the like of the baggage check usually include the airline due to reasons such as security and privacy policy.

Accordingly, the moving robot 1 according to the embodiment of the present invention may acquire the airline information by scanning the baggage check, and may search the flight information from a database or receive the flight information from a server, based on the airline information.

The communication unit 790 may communicate with a certain server. For example, the communication unit 790 may communicate with the control server of the airport.

The communication unit 790 may receive the arrival flight information of a plurality of airlines from the control server, and the received arrival flight information of the plurality of airlines may be stored in the storage unit 730.

In this case, the controller 740 may search the arrival flight of the airline from the arrival flight information stored in the storage unit 730 (S630).

If the arrival flight of the airline corresponding to the airline information acquired by the scan of the baggage check is not searched (S630), the controller 740 may control the second display 21 to display an input window for inputting flight information (S633).

When a user inputs certain flight information (S636), the controller 740 may search the flight inputted through the input window, from the arrival flight information stored in the storage unit 730 (S630).

According to the embodiment, the controller 740 may control the communication unit 790 to request for the arrival flight information of the airline to a certain server, based on the airline information acquired by the scanning of the baggage check.

The controller 740 may control the second display 21 to display a flight list including the searched or received arrival flight information (S640).

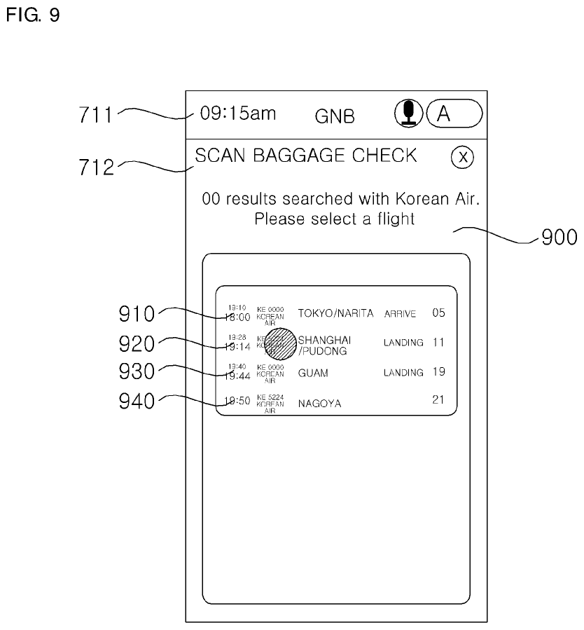

FIG. 9 illustrates a scan result screen displayed after the scanning is completed.

Referring to FIG. 9, a scan result screen 900 displayed on the second display 21 may include a flight list containing the arriving flight information 910, 920, 930, 940 of the airline acquired by the scanning.

The user may select any one of the arrival flight information 910, 920, 930, and 940 by a touch or voice input.

If there is only one flight information included in the scanning result, only one flight information may be selected after displaying the flight information, or only one flight information may be directly selected by omitting the displaying of the flight information.

The controller 740 may control the second display 21 to display the recognition result of the baggage check.

Thereafter, the user may select any one of a plurality of flights included in the arrival flight list by touch or voice input (S650).

If a certain flight included in the arrival flight list is selected (S650), the controller 740 may control the second display 21 to display detailed information including baggage claim information corresponding to the selected flight (S660).

Meanwhile, if there is only one flight included in the arrival flight list, the controller 740 may control the second display 21 to display directly the detailed information including baggage claim information corresponding to one flight (S660).

That is, if there is only one flight, the only one flight is automatically selected without waiting for the user's selection, and the detailed information can be provided to the user directly.

In some embodiments, in the case of only one flight, the flight list display (S640), flight selection (S650) may be omitted, and detailed information including baggage claim information corresponding to one flight may be displayed on the second display (S660).

If an escort service request for guiding to the baggage claim is received, the controller may control the moving robot 1 to enter an escort mode of guiding the user to the baggage claim.

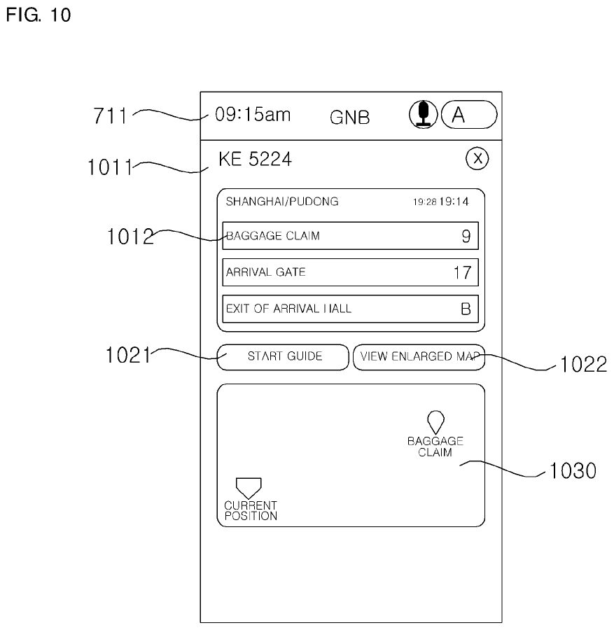

FIG. 10 illustrates a screen displaying detailed information including baggage claim information corresponding to a specific flight.

Referring to FIG. 10, the controller 740 may control the second display 21 to display the detailed information screen of the selected flight.

For example, when the moving robot 1 is disposed in the arrival hall of airport and a specific flight is selected, the detailed information screen may include detailed information 1012 such as flight name information 1011, baggage claim, arrival gate, the exit of the arrival hall, and the like.

In addition, the detailed information screen may include a map image 1030 containing the user's current position, the baggage claim position, and the path to the baggage claim that the moving robot 1 can guide among the detailed information 1012.

In addition, the detailed information screen may include a menu button such as an escort menu button 1021 for requesting an escort service that the moving robot 1 moves and guides to the baggage claim displayed on the map image 1030, and a map enlarging menu button 1022 for enlarging and displaying a map in the map image 1030.

When the user touches the escort menu button 1021 or requests the escort service by voice, the controller 740 may control the moving robot 1 to enter the escort mode.

Meanwhile, a global navigation bar area 711 in which menu and state information accessible from any screen are displayed may be disposed in the upper end of the second display 21.

The robot of the arrival hall has to check user's baggage desk by a bar code of user's baggage check. However, due to security and privacy issues, there is no information of the flight in the barcode but is only the airline information so that the flight and baggage claim cannot be guided directly.

However, according to the present invention, the moving robot 1 may periodically communicate with the control server through the communication unit 790 or receive a response after requesting necessary information. The controller 740 may control the moving robot 1 to guide directly if there is only one airline that currently uses the baggage claim, and to provide a menu for the user to select if there are a plurality of airlines that currently use the baggage claim.

The controller 740 may control the second display to display the recognition result of the baggage check.

If the recognition of the ticket such as the baggage check is unsuccessful or the baggage check is not inserted for a certain period of time, the controller 740 may control the first display 312 or the second display 21 to display a screen for notifying the recognition failure.

Alternatively, if the recognition of the ticket such as the baggage check is unsuccessful or the baggage check is not inserted for a certain period of time, the controller 740 may control the second display 21 to display a screen for guiding a flight search.

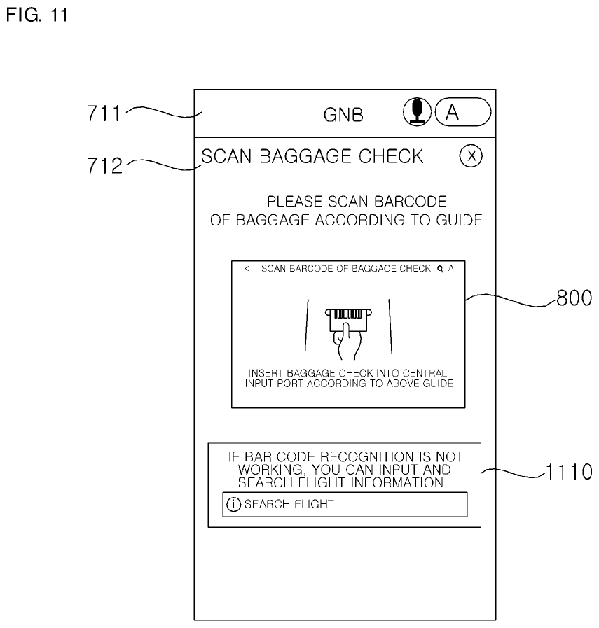

FIG. 11 shows an example of a user interface screen displayed when the baggage check recognition fails.

Referring to FIG. 11, when the recognition of the ticket, such as the baggage check, fails, or when the baggage check is not inserted for a certain time, the controller 740 may control the second display 21 to display a message for guiding a flight search and an input window 1110.

According to at least one of the embodiments of the present invention, specific information desired by people can be quickly and accurately searched and effectively provided.

Further, according to at least one of the embodiments of the present invention, it is possible to quickly find a baggage claim based on the baggage check.

Further, according to at least one of the embodiments of the present invention, an escort service can be provided to guide to the baggage claim, thereby improving user convenience.

The moving robot according to the present invention and the operation method for the same are not limited to the configuration and method of the embodiments described above, but the embodiments may be configured in such a manner that all or some of the embodiments may be selectively combined so that various modifications may be accomplished.

Meanwhile, the operation method of the moving robot of the present invention can be implemented as a processor-readable code on a recording medium readable by a processor. The processor-readable recording medium includes all kinds of recording apparatuses in which data that can be read by the processor is stored. Examples of the recording medium readable by the processor include a ROM, a RAM, a CD-ROM, a magnetic tape, a floppy disk, an optical data storage device, and the like, and may also be implemented in the form of a carrier wave such as transmission over the Internet. In addition, the processor-readable recording medium may be distributed over network-connected computer systems so that code readable by the processor in a distributed fashion can be stored and executed.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

What is claimed is:

1. An apparatus comprising:
a display; and
a controller configured to:
cause the display to display a user interface screen for a baggage;
acquire information from a baggage check presented to the apparatus; and
cause the display to display a list of at least one arrived airline flight based on the acquired information.

2. The apparatus of claim 1, wherein the at least one arrived airline flight is in a bag drop off state.

3. The apparatus of claim 1, wherein the list includes only airline flights arrived within a reference period of time.

4. The apparatus of claim 1, wherein the controller is further configured to cause the display to display detailed information including baggage claim information corresponding to an airline flight selected from the list.

5. The apparatus of claim 4, wherein the controller is further configured to:
cause the apparatus to enter an escort mode in response to an escort service request for guiding to a baggage claim location corresponding to the selected airline flight; and
cause the apparatus to move in the escort mode to guide to the baggage claim location.

6. The apparatus of claim 1, further comprising:
an input port configured to receive the baggage check;
a communication unit configured to receive arrived flight information of a plurality of airlines from a server; and
a storage unit configured to store the received arrived flight information of the plurality of airlines.

7. The apparatus of claim 6, wherein the controller is further configured to:
acquire the information from the baggage check received by the input port by scanning the baggage check; and
search an airline flight arrived at an airport from the arrived flight information stored in the storage unit.

8. The apparatus of claim 6, wherein the controller is further configured to cause the display to display an input window for receiving flight information when no airline flight corresponding to the information acquired by scanning the baggage check is searched.

9. The apparatus of claim 8, wherein the controller is further configured to search an airline flight from the flight information stored in the storage unit based on the flight information received via the input window.

10. The apparatus of claim 7, wherein the controller is further configured to cause the communication unit to transmit a request for arrived flight information to the server based on the information acquired by scanning the baggage check.

11. A method for operating an apparatus, the method comprising:
displaying a user interface screen for a baggage on a display;
receiving a baggage check;
acquiring information from the received baggage check; and
displaying a list of at least one arrived airline flight based on the acquired information.

12. The method of claim 11, wherein the at least one arrived airline flight is in a bag drop off state.

13. The method of claim 11, wherein the list includes only airline flights arrived within a reference period of time.

14. The method of claim 11, further comprising:
selecting any one of a plurality of airline flights included in the list in response to a touch or voice input; and
displaying detailed information, including baggage claim information corresponding to the selected airline flight, on the display.

15. The method of claim 14, further comprising:
receiving an escort service request for guiding to a baggage claim location corresponding to the selected airline flight; and
entering an escort mode in response to the escort service request,
wherein the apparatus moves in the escort mode to guide to the baggage claim location.

16. The method of claim 11, further comprising:
receiving the baggage check via an input port of the apparatus;
acquiring the information from the baggage check received by the input port by scanning the baggage check;
receiving arrived flight information of a plurality of airlines from a server via a communication unit of the apparatus; and
storing the received arrived flight information of the plurality of airlines in a storage unit of the apparatus.

17. The method of claim 16, further comprising searching an airline flight arrived at an airport from the arrived flight information stored in the storage unit.

18. The method of claim 16, further comprising displaying an input window for receiving flight information on the display when no airline flight corresponding to the information acquired by scanning the baggage check is searched.

19. The method of claim 18, further comprising searching an airline flight from the flight information stored in the storage unit based on the flight information received via the input window.

20. The method of claim 16, further comprising transmitting a request for arrived flight information to the server via the communication unit based on the information acquired by scanning the baggage check.
